(19) United States
(12) Patent Application Publication
(10) Pub. No.: US 2007/0233556 A1
(43) Pub. Date: Oct. 4, 2007

(54) Controlling the serving, with a primary document, of ads from a first source, subject to a first compensation scheme, and ads from a second source, subject to a second compensation scheme

(76) Inventor: Ross Koningstein, Menlo Park, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/396,228

(22) Filed: Mar. 31, 2006

(51) Int. Cl. G06Q 30/00

(52) U.S. Cl. 705/14

(57) ABSTRACT

An advertising entity manages determinations, bidding, and/or billing for serving “generic advertisements” on a primary document. Generic ads are not for specific merchants or products; rather they lead users to a secondary document containing more specific information, product listings, and/or merchant listings. Such information and/or listings are determined to be relevant to a generic concept corresponding to the generic ad. For example, when a user selects a generic ad, they may be presented with a secondary document including product listings. If the user selects a merchant's product listing, then that merchant compensates an ad serving entity and/or a publisher of the primary document. Such management might include choosing or generating an appropriate generic advertisement creative for a potential advertising situation. A determination of whether or not to render a generic ad instead of one or more typical advertiser-managed ads may use an expected value of rendering the generic ad versus showing the advertiser-managed ad(s). The result of this determination may be reflected in a bid associated with the generic ad. Generic ads will often be useful for primary documents (e.g., Web pages) that are non-specific.

### § 1. BACKGROUND OF THE INVENTION

§ 1.1 Field of the Invention

The present invention concerns online advertising.

§ 1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords™ advertising system by Google, Inc. of Mountain View, Calif. (referred to as “Google”), delivers ads targeted to keywords from search queries. Similarly, content targeted ad delivery systems have been proposed. For example, U.S. patent application Ser. Nos. 10/314,427 (incorporated herein by reference and referred to as “the '427 application”), titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and 10/375,900 (incorporated by reference and referred to as “the '900 application”), titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense™ advertising system by Google for example, have been used to serve ads on Web pages.

As can be appreciated from the foregoing, serving ads relevant to concepts of text in a text document and serving ads relevant to keywords in a search query are useful because such ads presumably concern a current user interest. Consequently, such online advertising has become increasingly popular.

Regardless of whether or how ads are targeted, an advertiser typically compensates the content owner and perhaps an ad serving entity (referred to more generally as a “document publisher” or “Web publisher”). Such compensation may occur whenever the ad is served (per impression), or may be subject to a condition precedent such as a selection, a conversion, etc. Compensation per selection (commonly referred to as “pay per click”) is currently becoming popular. For example, when a user selects an ad, they are brought to (e.g., their browser loads) a corresponding ad landing page linked from the ad. The advertiser compensates the Web publisher for the selection.

Although services such as Google's AdSense™ have enabled advertisers to target ads to the topics or concepts of content on a Web page, some Web pages are fairly general (e.g., those pertaining to general categories such as autos, careers, health, etc.) which makes it difficult to achieve high levels of ad performance, such as the levels of ad performance associated with ads targeted to Web pages having more specific concepts and topics. This is unfortunate because Web pages with more general content are often the most heavily visited (e.g., have the most “page views”). A similar problem arises for Web pages pertaining to a number of different categories.

U.S. patent application Ser. No. 10/814,101 (incorporated herein by reference and referred to as “the '101 application”), titled “PROVIDING LINKS TO RELATED ADVERTISEMENTS,” filed on Mar. 31, 2004 and listing Brian AXE, Jerry FELKER, and Ross KONINGSTEIN as inventors describes techniques to help advertisers and Web publishers to bring more useful, relevant ads to users, even in the case of Web pages with more general content. However, the embodiments described in the '101 application could improved.

For example, the present inventor believes that online advertisers would rather focus on running and scaling their business than spending time setting up and maintaining advertising campaigns. For example, it is challenging and time consuming to create ads that generate more leads. The work online advertisers must undertake in typical keyword oriented search advertising includes selecting keywords used to target the serving of their ads, determining bids, and writing ad creatives.

In view of the foregoing, it would be useful to provide an online advertising techniques that allow advertisers to avoid or minimize challenging and time consuming tasks such as, for example, bid management, creative input, etc. It would be particularly useful if such techniques provide a high-quality (advertisement) experience for the end-user. It would be particularly useful if such techniques provide cost effective advertisements for the merchants seeking specific leads. Finally, it would be particularly useful if such techniques were provided in the context of a viable business model for an advertising distributor (also referred to as an “ad serving entity”).

### § 2. SUMMARY OF THE INVENTION

Embodiments consistent with the present invention may be used to provide “generic leads” or “generic advertisements” to present users with product listing Web pages or Websites (more generally referred to as a “product listing document”), particularly when the product listing document can offer a range of merchants, and/or products of interest to the user.

In at least some embodiments consistent with the present invention, generic advertisements to such product listing documents are targeted by a category or genre. In at least some embodiments consistent with the present invention, such generic advertisements have creatives that differ from merchant product-by-product listings.

In at least some embodiments consistent with the present invention, the ad serving entity compensates the document publisher for hosting the generic ad(s) (e.g., that are acted on (e.g., selected) by end users) regardless of whether merchants pay or don't pay for any resultant actions by the end-user. In at least some alternative embodiments consistent with the present invention the document publisher is only compensated if the ad serving entity is compensated by a merchant having a product listing on a secondary document linked from a generic ad.

At least some embodiments consistent with the present invention improve ad serving by (a) accepting an ad request, (b) determining at least one candidate generic ad and zero or more candidate advertiser-managed ads relevant to the ad request, (c) determining a score for each of the candidate generic ads and candidate advertiser-managed ads, (d) determining a set including at least one of the candidate generic ads, and/or at least one of the candidate advertiser-managed ads using the scores, and (e) serving the determined set of one or more ads.

### § 3. BRIEF DESCRIPTION OF THE DRAWINGS

FIG. 1 is a diagram showing parties or entities that can interact with an advertising system.

FIG. 2 is a diagram illustrating an environment in which, or with which, embodiments consistent with the present invention may operate.

FIG. 3 is a bubble diagram of exemplary operations that may be performed in a manner consistent with the present invention, as well as information that may be used and/or generated by such operations.

FIGS. 4A and 4B are flow diagrams of exemplary methods for performing various ad-related operations in a manner consistent with the present invention.

FIG. 5 illustrates an example of a primary click of a generic ad rendered on a primary document, as well as a secondary click of a product listing or of an advertiser managed ad provided on a secondary (product listing) document linked from, or generated by, the selected generic ad.

FIG. 6 illustrates another example of a secondary click on a document that is indirectly linked from a selected generic ad.

FIG. 7 is a block diagram of apparatus that may be used to perform at least some operations, and store at least some information, in a manner consistent with the present invention.

### § 4. DETAILED DESCRIPTION

The present invention may involve novel methods, apparatus, message formats, and/or data structures for determining a set of advertiser-managed ad(s) and/or generic ad(s) to be served with a primary document. The present invention may also involve novel methods, apparatus, message formats, and/or data structures for generating charges and/or credits for serving generic ad(s), for user interactions with generic ad(s), and/or for user interactions with product listings on a secondary document linked from, or generated by, generic ad(s). The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Also, as used herein, the article “a” is intended to include one or more items. Where only one item is intended, the term “one” or similar language is used. In the following, “information” may refer to the actual information, or a pointer to, identifier of, or location of such information. No element, act or instruction used in the description should be construed as critical or essential to the present invention unless explicitly described as such. Thus, the present invention is not intended to be limited to the embodiments shown and the inventor regards his invention to include any patentable subject matter described.

In the following definitions of terms that may be used in the specification are provided in § 4.1. Then, environments in which, or with which, the present invention may operate are described in § 4.2. Exemplary embodiments of the present invention are described in § 4.3. Thereafter, specific examples illustrating uses of exemplary embodiments of the present invention are provided in § 4.4. Finally, some conclusions regarding the present invention are set forth in § 4.5.

### § 4.1 DEFINITIONS

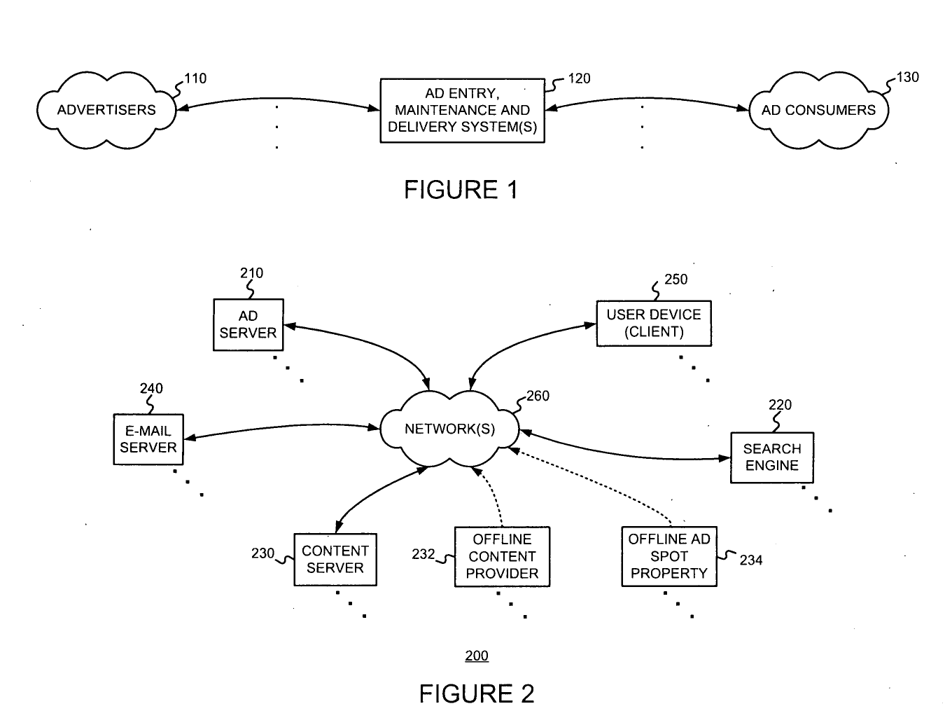

Online ads, such as those used in the exemplary systems described below with reference to FIGS. 1-3, or any other system, may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document, on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate” or “CTR”) of the ad.

“Generic ads” include advertisements that pertain to a class or category, such as a product-class or product-category. Generic ads may include a link to a secondary document and/or executable code for initiating the generation of a secondary document. The secondary document may be a product listing document such as a Web page generated by the Froogle™ service from Google for example. It might not be feasible for a single advertiser to be listed in this type of ad, since the ad is intended to inform the user about more than one merchant or product.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) and the ratio of the number of conversions to the number of selections (or the number of some other earlier event) are both referred to as the “conversion rate” or “CR.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, an MP3 audio program, online games, etc.), offline content (e.g., a newspaper, a magazine, a theatrical production, a concert, a sports event, etc.), and/or offline objects (e.g., a billboard, a stadium score board, and outfield wall, the side of truck trailer, etc.). Properties with content (e.g., magazines, newspapers, Websites, email messages, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, etc.).

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

A “Web document” includes any document published on the Web. Examples of Web documents include, for example, a Website or a Web page.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a media property (e.g., document). A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner. A “document publisher” is an example of a content owner.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

### § 4.2 EXEMPLARY ADVERTISING ENVIRONMENTS IN WHICH, OR WITH WHICH, THE PRESENT INVENTION MAY OPERATE

FIG. 1 is a diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., cost, average cost, or maximum cost (per impression, per selection, per conversion, etc.)). Therefore, a single cost, a single maximum cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways.

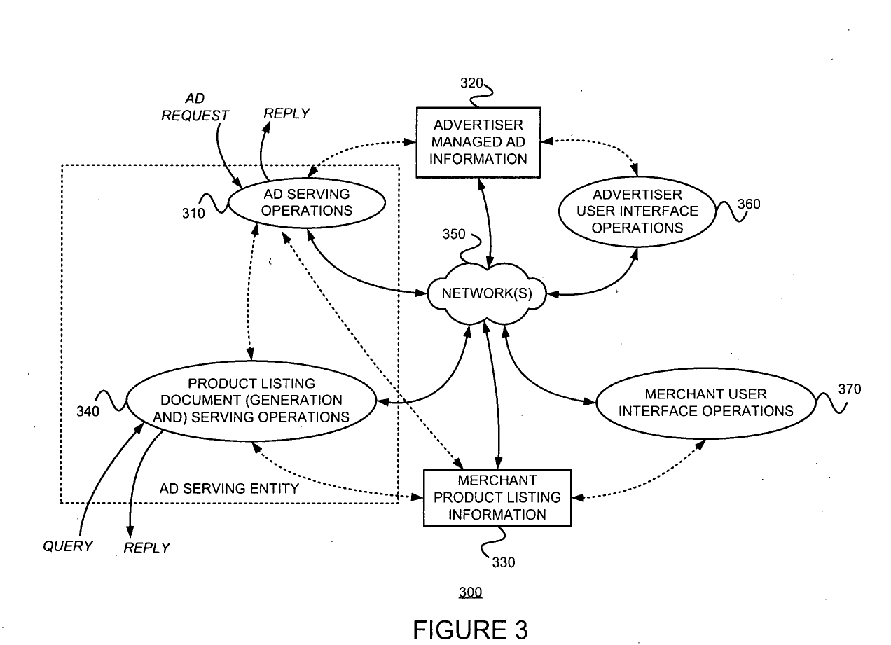

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). A content server 230 may permit user devices 250 to access documents. An e-mail server (such as GMail from Google, Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities.

As discussed in the '900 application, ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

The offline content provider 232 may provide information about ad spots in an upcoming publication, and perhaps the publication (e.g., the content or topics or concepts of the content), to the ad server 210. In response, the ad server 210 may provide a set of ads relevant the content of the publication for at least some of the ad spots. Examples of offline content providers 232 include, for example, magazine publishers, newspaper publishers, book publishers, offline music publishers, offline video game publishers, a theatrical production, a concert, a sports event, etc.

Owners of the offline ad spot properties 234 may provide information about ad spots in their offline property (e.g., a stadium scoreboard banner ad for an NBA game in San Antonio, Tex.). In response, the ad sever may provide a set of ads relevant to the property for at least some of the ad spots. Examples of offline properties 234 include, for example, a billboard, a stadium score board, and outfield wall, the side of truck trailer, etc.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, selection or not, impression time, impression date, size, conversion or not, etc.) back to the ad server 120/210. Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

### § 4.3 EXEMPLARY EMBODIMENTS

The present inventor believes that it is a much simpler task for merchants to submit information for product listings (such as those that appear on Froogle.com) than to create ads that generate more leads. More specifically, submitting information for product listings allows merchants to avoid or minimize challenging and time consuming tasks (e.g., bid management, creative input, etc.) associated with running an online ad campaign.

The present inventor believes that, at least in some situations such as a page view of a Web page with more general content, it may be better for an end user to be presented with (e.g. fewer) generic ads than (e.g., a multitude of) specific ads. For example, in the context of a Web page about cameras, it may be less useful for a user to see many ads for specific Nikon and Minolta Cameras, for example, rather than one (uncluttered) ad for SLR cameras that takes them to a secondary document (e.g. a product listing document which may include product listings and/or advertiser managed ads) that has more specific information. Since the end user's experience may well be better with fewer ads, depending on the ad server behavior, the generic ad(s) might, in turn, be a better value to the document publisher on whose content (e.g., Web page) the ad(s) are rendered. Further, since the primary document is less cluttered, the end-user's experience on the primary document should be improved.

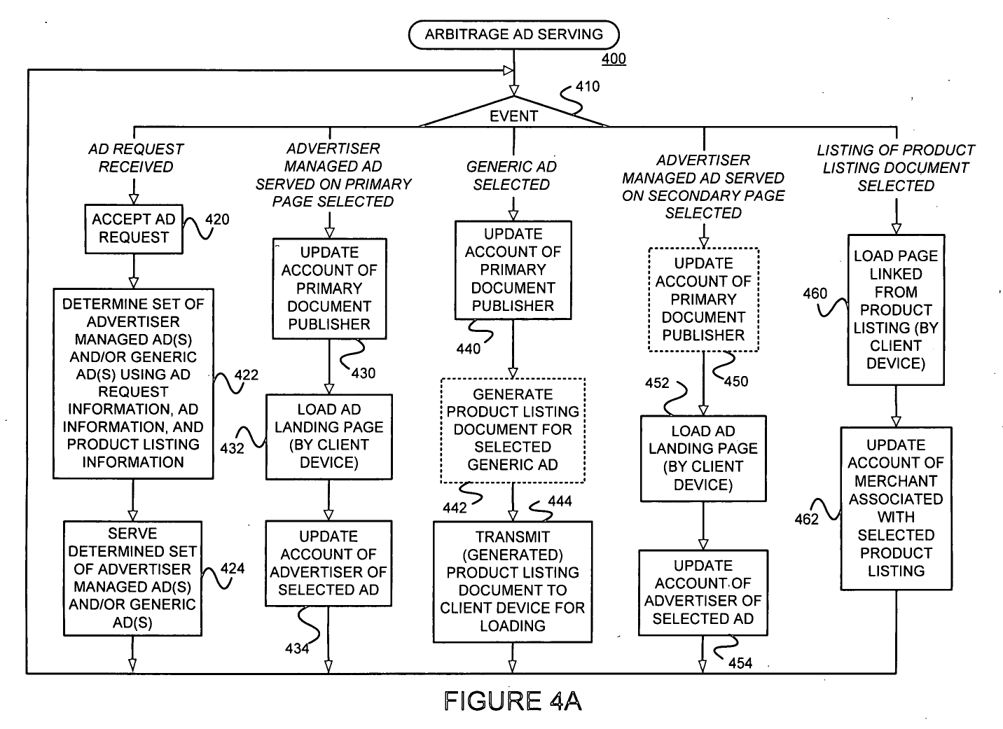

FIG. 3 is a bubble diagram of an environment 300 including exemplary operations that may be performed in a manner consistent with the present invention, as well as information that may be used and/or generated by such operations. The environment 300 may include ad serving operations 310, advertiser-managed ad information 320, advertiser user interface operations 360, merchant product listing information 330, product listing document (generation and) serving operations 340, merchant user interface operations 370 and one or more networks 360, such as the Internet for example. The ad serving operations 310 may (1) receive requests for one or more ads, (2) determine a set of advertiser-managed ad(s) (e.g., using the ad request information and advertiser-managed ad information 320), and/or generic ad(s) (e.g., using the ad request information and merchant product listing information 330), and (3) provide the determined set in a reply.

The advertiser-managed ad information 320 may include ad account information such as that described above. In at least some exemplary embodiments consistent with the present invention, the advertiser-managed ad information 320 may include ad information like that found in the AdWordS™ advertising service offered by Google. Advertiser user interface operations 360 permit advertisers to manage their ad information 320. In at least some exemplary embodiments consistent with the present invention, the advertiser user interface operations 360 may include operations like those provided in the advertiser front end user interface of the AdWords™ advertising service offered by Google.

The merchant product listing information 330 may include product information such as that found in the Froogle™ service offered by Google. Merchant user interface operations 370 permit merchants to enter (e.g., upload) product listing information 330. In at least some exemplary embodiments consistent with the present invention, the merchant user interface operations 370 may include operations like those provided in the merchant center of the Froogle™ service offered by Google.

In at least one exemplary embodiment consistent with the present invention, merchants may use merchant user interface operations 370 to enter (e.g., upload) product listings. For example, using such merchant user interface operations 370, the merchant might (1) sign in (e.g., create or use an existing account to enter the a merchant user interface center), (2) create a file transfer protocol (“FTP”) account to be used by the merchant to upload product feeds, (3) specify product feed settings (e.g., filename and other parameters), (4) create and upload the product feed, and (5) check the product feed for errors (e.g., formatting errors). A product feed might be is a simple text file listing a merchant's product information.

Each product included in a product feed may include information used to generate a product listing. Such information may include one or more of: (1) a product URL (e.g., the Web page that the product appears on); (2) product name (e.g., the product's name or title as it appears on the product page); (3) product description (e.g., as it appears on the product page); (4) product image URL; (5) product category (e.g., the category (and subcategories) that the product appears under on the merchant's Website); (6) product price (e.g., listed on the Merchant's Website); (7) in stock (e.g., is the product currently available? Y or N.); (8) shipping (e.g., the merchant's lowest shipping & handling cost for the product, if it offers flat shipping fees within the U.S.); (9) brand/manufacturer of the product; (10) Product UPC code; (11) Unique product ID code (e.g., manufacturerupc_id assigned by its manufacturer); (12) product_type (e.g., book, music, video, other, etc.); (13) currency of listed price (e.g., using ISO 4217 code); (14) merchant Website language (e.g., using ISO 639 language code); (15) a list all countries that the merchant ships its products to (e.g., using the ISO 3166 country codes); and (16) the location(s) the merchant ships its products from (e.g., using the ISO 3166 country codes). In at least some embodiments consistent with the present invention, the content in the product feed must be consistent with (e.g., the same as) content visible to users on the merchant's Website.

The merchant may also provide a business feed (e.g., a text file uploaded to the product listing document (generation and) serving operations 340) used to allow the merchant to add, edit, or delete information about its business and physical location(s).

In at least some embodiments consistent with the present invention, each product listing (or each product feed, or each merchant) may include an indication of whether or not the product listing (e.g., of a product feed or of a merchant) is to be included in an “upsell” program. If a product listing is not to be included in the upsell program, the product listing may provided in product listing documents (e.g., Web pages) under a low cost structure (e.g., free inclusion, as in the case of product listings on Froogle™ from Google). If, however, a product listing is to be included in the upsell program, the merchant agrees to pay a fee for impressions of the product listing, user selections of the product listing, and/or conversions on the product listing. The fee may be a flat fee across all product listings and all merchants. Alternatively, the fee may be a flat fee across all product listings of a particular merchant. Alternatively, the fee may be per product. Alternatively, the fee may be per product category or class. The fee might be specified by the ad serving entity. Alternatively, the fee might be specified by the merchant. In at least some embodiments consistent with the present invention, a fee might include component fees such as those just described above. In at least some embodiments consistent with the present invention, fees for impressions of the product listing, user selections of the product listing, and/or conversions on the product listing might be waived or reduced (e.g., subsidized) for a limited time to encourage product merchants to try such an upsell program with little or no risk.

The product listing document (generation and) serving operations 340 may accept queries (e.g., related to products) and generate replies using the query information and the merchant product listing information 330. An example of such operations is the Froogle™ service offered by Google.

The ad serving operations 310 may use merchant product listing information 330, obtained either directly or via the product listing document (generation and) serving operations 340, in a product listing document.

As can be appreciated from the foregoing, although advertiser-managed ad information 320 and merchant product listing information 330 may include some similar types of information, information of an advertiser-managed ad will likely be different than information of a merchant product listing in at least some ways. The way in which advertisers compensate the ad serving system and/or document publishers (e.g., for ad impressions, ad selections, and/or ad conversions) will likely be different than the way in which merchants compensate the ad serving system and/or document publishers (e.g., for listing impressions, listing selections, and/or listing conversions) and the way the ad serving entity might compensate the document publisher (e.g., for generic ad impressions, generic ad selections, generic ad conversions, etc.). Thus, at least some embodiments consistent with the present invention might apply a first compensation scheme for generic ads and product listings and a second compensation scheme for advertiser-managed ads.

As indicated, the ad serving operations 310 and product listing document (generation and) serving operations 340 may belong to (e.g., be performed by, or under the control of) an ad serving entity. Although not indicated, the advertiser-managed ad information 320 and/or the merchant product listing information 330 may also belong to (e.g., be stored and/or accessed by) an ad serving entity. Finally, although not indicated, the advertiser user interface operations 3.60 and/or the merchant user interface operations 370 may belong to the ad serving entity.

§ 4.3.1 Exemplary Methods

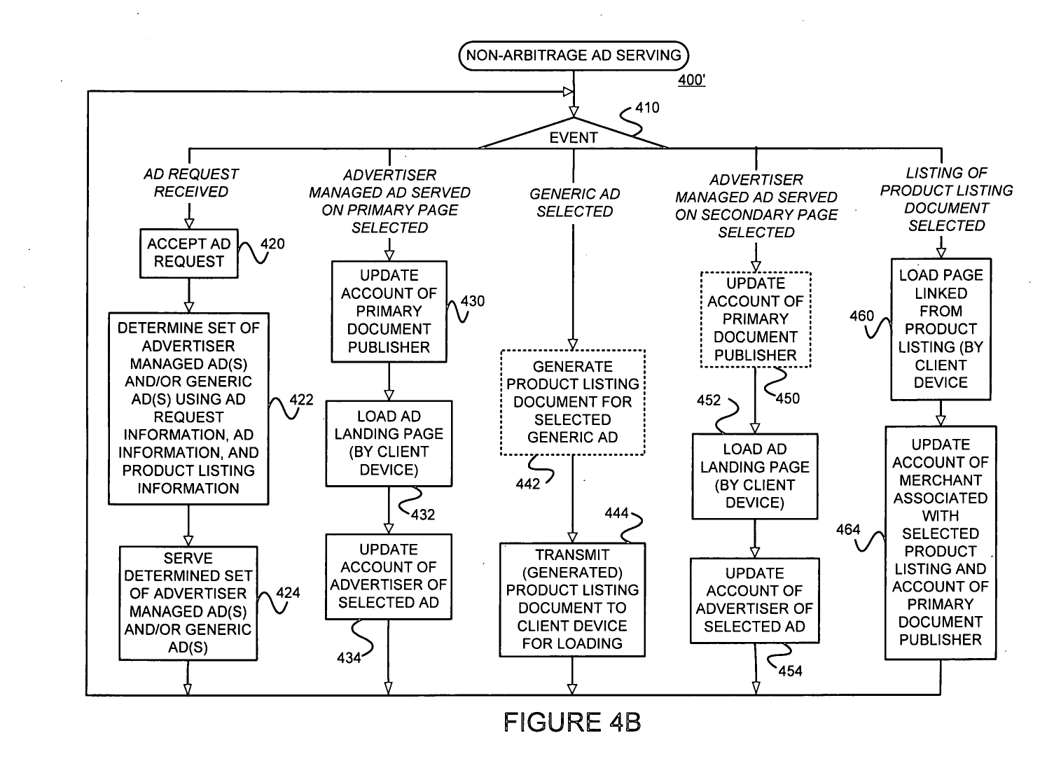

FIGS. 4A and 4B are flow diagrams of an exemplary methods 400 and 400′, respectively, for performing various ad-related operations in a manner consistent with the present invention. Generally, under the method 400 of FIG. 4A, a primary document publisher is compensated for generic ad selection (or impression) regardless of subsequent conditions. On the other hand, under the method 400′ of FIG. 4B, a primary document publisher is only compensated for a generic ad selection (or impression) if a subsequent condition is met. As will be appreciated from the following description, an ad serving entity might engage in arbitrage using the method 400 of FIG. 4A, or may avoid the risks (and rewards) or arbitrage using the method 400′ of FIG. 4B.

Referring first to FIG. 4A, as indicated by event block 410, various branches of the method 400 may be executed in response to the occurrence of various events. For example, if an ad request is received, the acts corresponding to the left-most branch of the method 400 may be performed. Specifically, the ad request may be accepted (Block 420) and a set of one or more advertiser-managed ads and/or one or more generic ads may be determined using ad request information, ad information and product listing information (Block 422). To reiterate, a “generic ad” might be an ad that pertains to a class or category, such as a product-class or product-category. A generic ad might include a link to a secondary document and/or executable code for generating a secondary document. The secondary document might be a product listing document such as a Web page generated by the Froogle™ service from Google for example. The determined set of advertiser-managed ad(s) and/or generic ad(s) may then be served. For example, the advertiser managed ad(s) and/or generic ad(s) may be served with (e.g., in ad spots) of a document (e.g., a Web page) associated with the ad request. This document is considered to be controlled by a document publisher (e.g., a Web publisher), and may be referred to as a “primary document”. The publisher may be an ad server such as Google, or a third party publisher participating in an advertising network, such as the AdSense™ service from Google.

Referring back to event block 410, if a previously served advertiser-managed ad on the primary page is selected, the primary document publisher's account is updated (Block 430), an ad landing page associated with the selected ad is loaded (by the end user's client device (e.g., into a browser)) (Block 432), and the account of the advertiser of the selected ad is updated (Block 434). Note that the ad serving entity might be, but need not be, involved with loading the ad landing page into the client device.

Referring back to event block 410, if a generic ad is selected, the primary document publisher's account is updated (Block 440) and a product listing document is transmitted to the client device for loading by the client device (Block 444). Note that if a product listing document is not already available, it may be generated for the selected generic ad. (Block 442) For example, category term(s) (e.g., “MP3 Players”) associated with the generic ad might be used as a query to a Froogle-like service. Note that the ad serving entity might be, but need not be, involved with transmitting the product listing document to the client device.

Referring back to event block 410, if a particular listing of the product listing document is selected, a document (e.g., merchant Web page) linked from the product listing may be loaded onto the client device (by the client device) (Block 460) and the account of the merchant associated with the selected product listing (Block 462) may be updated. Note that the ad serving entity might be, but need not be, involved with loading the product listing page into the client device.

In at least some embodiments consistent with the present invention, at least some product listing documents might include advertiser-managed ads in addition to product listings. Referring back to event block 410, if a previously served advertiser-managed ad on the product listing page is selected, the primary document publisher's account might be updated (e.g., again) (Block 450), an ad landing page associated with the selected ad is loaded (by the end user's client device (e.g., into a browser)) (Block 452), and the account of the advertiser of the selected ad is updated (Block 454). Note that the ad serving entity might be, but need not be, involved with loading the ad landing page into the client device.

Still referring to block 450, in some embodiments consistent with the present invention, a primary document publisher might only be compensated for selections of (generic and advertiser-managed) ads rendered on its page—the primary document. In such embodiments, the publisher is not compensated for user actions with respect to product listings, advertiser-managed ads, etc. on any secondary documents, such as a product listing document. However, in other embodiments consistent with the present invention, the publisher of the primary document might receive additional compensation, perhaps subject to a maximum, for user actions with respect to product listings, advertiser-managed ads, etc. on any secondary documents, such as a product listing document.

Referring back to block 422, the act of determining a set of advertiser managed ad(s) and/or generic ad(s) using the ad request information, ad information and product listing information may be performed in a number of alternative ways. Note that if the advertisers and merchants pay for ad selections and product listing selections, respectively, and if the entity running the ad system (referred to as “the ad serving entity”) pays primary document publishers for ad selections, the ad serving entity has the potential risks and rewards of arbitrage. For example, in a pay-per-selection situation, the primary document publisher has no risk when serving advertiser-managed ads because, as shown in the second left-most branch of FIG. 4, if an advertiser-managed ad is selected, the primary document publisher is compensated and the advertiser is charged. However, the ad serving entity incurs a risk when serving a generic ad since, if the generic ad is selected, the primary document publisher is compensated (by the ad serving entity) as shown in the third left-most branch of FIG. 4, but the ad serving entity is only compensated by a merchant if a product listing is later selected as shown in the right-most branch of FIG. 4A. In at least some pay-per-selection embodiments, the ad server may determine the set of advertiser managed ad(s) and/or generic ad(s) as follows. A candidate (e.g., relevant) generic ad should be rendered instead of zero or more candidate advertiser-managed ads if the expected revenue for the generic ad is higher than the expected revenue for the replaced advertiser managed ad(s). The expected revenue for the generic ad might be the product of a selection rate of the generic ad and an expected value of a product listing document impression (e.g., secondary page view).

Referring now to FIG. 4B, the method 400′ is similar to that 400 of FIG. 4A. However, referring to the middle branch of method 400′ if a generic ad is selected, the account of the primary document publisher is not updated. (Compare with block 440 of FIG. 4A.) Thus, the primary document publisher might not be compensated for a selection of a generic ad (unless a subsequent condition is met). Referring to the right-most branch of method 400′, if a product listing of the product listing document is selected, the accounts of both (1) the merchant associated with the selected product listing and (2) the account of the primary document publisher are both updated. (Block 464) Thus, in the method 400′ of FIG. 4B, the ad serving entity need not incur the risk of compensating the primary document publisher without knowing whether it will be compensated by a merchant(s). Nonetheless, referring back to block 422, in at least some pay-per-selection embodiments, the ad serving entity may determine the set of advertiser managed ad(s) and/or generic ad(s) in the same or similar manner as described above with reference to the method 400 of FIG. 4A. That is, a candidate generic ad should be rendered instead of zero or more candidate advertiser-managed ads if the expected revenue for the generic ad is higher than the expected revenue for the replaced advertiser managed ad(s). The expected revenue for the generic ad might be the product of an expected selection rate of the generic ad and an expected value of a product listing document impression (e.g., secondary page view).

Although the methods 400 and 400′ were described in the context of (i) ad serving entity to primary document publisher compensation based on advertiser-managed ad and generic ad selections, (ii) advertiser to ad serving entity compensation based on advertiser-managed ad selections, and (iii) merchant to ad serving entity compensation based on product listing selections, other embodiments consistent with the present invention might use other events (e.g., impressions of, conversions on, etc., advertiser-managed ads, generic ads, and/or product listings), or various combinations thereof, on which to base compensation.

§ 4.3.2 Exemplary Apparatus

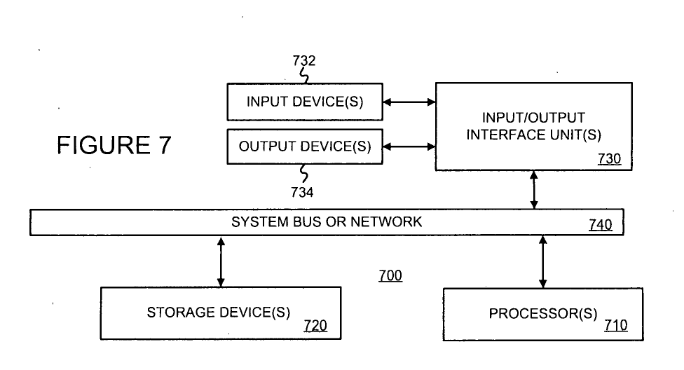

FIG. 7 is a block diagram of apparatus 700 that may be used to perform at least some operations, and store at least some information, in a manner consistent with the present invention. The apparatus 700 basically includes one or more processors 710, one or more input/output interface units 730, one or more storage devices 720, and one or more system buses and/or networks 740 for facilitating the communication of information among the coupled elements. One or more input devices 732 and one or more output devices 734 may be coupled with the one or more input/output interfaces 730.

The one or more processors 710 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 720 and/or may be received from an external source via one or more input interface units 730.

In one embodiment, the machine 700 may be one or more conventional personal computers. In this case, the processing units 710 may be one or more microprocessors. The bus 740 may include a system bus. The storage devices 720 may include system memory, such as read only memory (ROM) and/or random access memory (RAM). The storage devices 720 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 732, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 710 through an appropriate interface 730 coupled to the system bus 740. The output devices 734 may include a monitor or other type of display device, which may also be connected to the system bus 740 via an appropriate interface. In addition to (or instead of) the monitor, the personal computer may include other (peripheral) output devices (not shown), such as speakers and printers for example.

The operations described above may be performed on one or more computers. Such computers may communicate with each other via one or more networks, such as the Internet for example. Referring back to FIG. 3 for example, the various operations and information may be embodied by one or more machines 700.

§ 4.3.3 Refinements and Alternatives

In one example, the ad serving entity can place a generic ad on the property (e.g., primary document) of a third party, but the ad serving entity's compensation to the third party is conditioned on the occurrence of both (i) the selection of the generic ad and (ii) the ad serving entity being paid by a merchant for an product listing placed on the secondary page (e.g., on a per impression basis, a per selection basis, a per conversion basis, etc.). The amount of the ad serving entity's compensation to the third party might be a function of the ad serving entity being paid by a merchant for a product listing placed on the secondary page (e.g., on a per impression basis, a per selection basis, a per conversion basis, etc.). In this first example, the ad serving entity does not (or need not) assume any risk.

In a second example, the ad serving entity can place such a generic ad on the property of a third party, and the ad serving entity must pay the third party (e.g., for a click, or perhaps even the impression), irrespective of whether or not the ad serving entity generates any revenue from the product listing document (secondary page). In this scenario, the ad serving entity is acting as an arbitrageur, and is assuming some risk. However, the ad serving entity should have sufficient data to minimize such risk and make good decisions about whether or not to place a generic ad (which decision may be carried out by controlling a bid by the ad serving entity for having its generic ad served in an ad spot).

In yet another example, the ad serving entity can do something similar to the second example, but decide whether to “bump” an advertiser-managed ad (or ads) in favor of a generic ad (with a link to a product listing document, or with code for initiating the generation of a product listing document). In still yet another example, the publisher of the primary document may require that ads—whether generic ads or advertiser-managed ads—have a minimum level of quality (e.g., minimum click-through rate) to be rendered on the primary document. In such instances, an ad serving entity may serve a generic ad, of sufficient quality, in the event that advertiser-managed ads (if any) are of insufficient quality. The ad serving entity might also select candidate generic ads and/or advertiser-managed ads to be served on a primary document such that the served ads are expected to meet the quality requirement(s).

As can be appreciated from the foregoing, compensation to primary document publisher might be conditioned on (or be a function of) (a) an action (e.g., impression, selection, etc.) on the primary document without regard to what occurs on the secondary document, or (b) an action (e.g., impression, selection, etc.) on secondary document, assuming that the generic ad on the primary document was selected. Thus, compensation events can occur in various ways. In a first way, on generic ad selection on the primary document, the ad serving entity compensates the primary document publisher and on product listing selection on the secondary document, the merchant compensates the ad serving entity. In a second way, on generic ad selection on the primary document, the parties do nothing and on product listing selection on the secondary document, the merchant compensates the ad serving entity and the ad serving entity compensates the primary document publisher.

The ad serving entity has several options depending on the compensation situations at both the primary document (e.g., cost per impression, cost per selection, etc.) and the product listing (secondary) document (e.g., cost per impression, cost per selection, cost per conversion, etc.). For example, to reiterate, if compensation is per-selection for both ads on the primary document and product listings on the product listing (secondary) document, the ad serving entity can incur compensation to the primary document publisher before any merchant-billable event such as a product listing selection.

Determining expected value for the secondary (product listing) document is important for good arbitrage (and for maximizing revenues in non-arbitrage situations). Provided sufficient statistical data is available, it is easy to determine if a generic ad should be rendered instead of one or more advertiser-managed ads. Specifically, in at least some embodiments consistent with the present invention, a generic ad is served if the product of expected revenue per secondary document impression (e.g., page view) and the generic ad selection rate is higher than the sum of expected revenue of the one or more advertiser-managed ads that the generic ad replaced on the primary document. If ads on the primary document and product listings on the secondary document are both pay-per-impression, then it is easy for the ad serving entity to determine whether to provide a generic ad since the expected value of the secondary (product listing) document impression (page view) is easy to compute. If the ads on the primary document are pay-per-impression, but the product listings on the secondary (product listing) document are pay-per-selection, then expected value of the secondary document is computed based on the expected values of those product listings. This expected revenue of the secondary document then becomes the a (maximum) cost-per-impression bid for a generic ad impression on the primary document. As can be appreciated from the foregoing examples, basically, expected revenue from a generic ad impression is compared with expected revenue of one or more advertiser-managed ads which the generic ad might replace. The expected revenue from a generic ad may be a product of a selection rate of the generic ad, and an expected value of a secondary document impression (page view).

If, on the other hand, compensation to the primary document publisher is conditioned on (or is a function of) an action (e.g., impression, selection, etc.) on the secondary document, assuming that the generic ad on primary page was selected, the ad serving entity need not engage in arbitrage since it assumes no risk. However, the ad serving entity will nonetheless want to maximize revenues. Consequently, the foregoing determinations can be made regardless of whether or not the compensation to the publisher of the primary document is conditioned on receipt of compensation from a merchant with a product listing on the secondary document.

At least some embodiments consistent with the present invention may use hybrid compensation schemes where a portion of compensation to the primary document publisher is guaranteed (per generic ad impression or selection on the primary document), and another portion of compensation to the primary document publisher is subject to a condition being met (typically a condition that will trigger compensation to the ad serving entity by a merchant).

The primary document might be (a) the property of the ad serving entity or (b) the property of a third party. If the primary page is the property of a third party, the determination of the set of advertiser managed ad(s) and/or generic ads may be run by (a) the ad serving entity or (b) the third party itself. In the later case, the ad serving may participate in an arbitration (e.g., auction) used by the third part to determine ads to serve. The ad serving entity might provide a bid derived from an expected value of an impression or selection of the generic ad.

Some of the foregoing examples were simplified and those skilled in the art will be able to apply the basic concepts disclosed above to more complex ad auctions. For example, in auctions that score ads by a product of CPC bid and CTR, the CPC bid generated for a generic ad should be no higher than the expected revenue per impression (page view) of the secondary product listing document. Whether or not the generic ad will replace one or more advertiser-managed ads, however, will be determined by the rules of an ad arbitration process (e.g. the auction in used in AdWords™). Moreover, whether the auction charges a bid amount, or discounts a maximum bid amount might affect the bid determined for the generic ad.

### § 4.4 EXAMPLES OF OPERATIONS IN EXEMPLARY EMBODIMENTS CONSISTENT WITH THE PRESENT INVENTION

Scenario 1

Assume that a user is viewing a Web page with content related to hiking trips in Nepal. Assume that there are generic topic-based advertisements placed on the Web page—one for hiking shoes and another for camping equipment. The ad serving entity automatically targeted, created and placed these generic ads in content syndication. These generic ads have no mention of any specific merchant and product combination. For example, the ad for hiking shoes might include neither a specific brand nor a specific merchant. Such an ad might be considered to be a “generic product and merchant ad”. However, in at least some embodiments consistent with the present invention, the generic ad may be a “generic product” ad which might recommend a hiking shoe merchant in the user's area, without mentioning a specific brand. Similarly, in at least some embodiments consistent with the present invention, the generic ad may be a “generic merchant” ad which might recommend Nike hiking shoes, but not a specific merchant.

Assume that the user clicks the hiking shoes ad. An automatically-generated Froogle™ or Froogle-like Web page that lists hiking shoes suitable for mountain terrain is loaded into the user's browser. In this example, these product listings contain only automatically selected Froogle merchants that are participating in an “upsell” program. The content provider (i.e., the primary document publisher) is paid according to a revenue share formula, whose input is the estimated revenue per impression for the automatically generated product listing Web page.

Assume that the user clicked a product listing. In such a case, the merchant would get charged for (the cost of) the click on the generic ad on the primary document, payable to the ad serving entity. Since the user clicked on the hiking shoes ad, a payment is also made to the primary document publisher (by the ad serving entity), subject to some revenue sharing or media buy agreement. If that merchant is participating in a promotional program, then the ads-serving entity might cover or at least reduce (e.g., subsidize) the cost of paying the primary document publisher (or forego revenue if the ad serving entity is the primary document publisher), in anticipation of future revenues should that merchant subsequently opt into an upsell program.

In the foregoing scenario, the merchant did not need to create an ad. Rather, they just provided input to Froogle™. The ad serving entity automatically generated a generic ad pointing to an automatically generated Froogle™ Web page, because it predicted that the predicted revenue per page view for the target Froogle™ Web page was greater that the estimated revenue per impression for the replaced advertiser ad(s).

Scenario 2

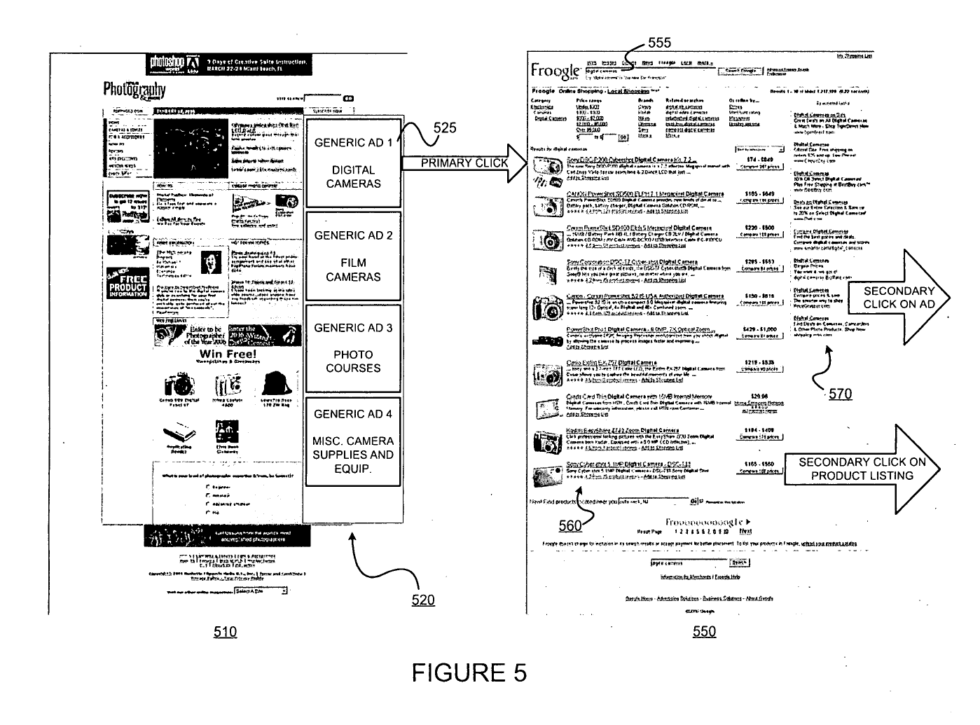

Referring to FIG. 5, the home page 510 of the Website “Photography and Imaging” may concern multiple categories, or a general category having multiple sub-categories—digital cameras, film cameras, photography, camera supplies and equipment. In this example, the ad serving entity decides to replace advertiser-managed ads, which are often targeted to specific products, with generic ads 520 for “digital cameras”, “film cameras”, “photography courses” and “miscellaneous camera supplies and equipment” on the Web page 510. Note that the Web page 510 can be thought of as a primary document.

Suppose that the first generic ad 525, for “digital cameras” is selected (e.g., clicked) by a user. A Froogle-like Web page 550, generated using the query term “digital cameras” (e.g., from generic ad 1 525) 555 is loaded into the user's browser. Note that the Froogle-like Web page 550 can be thought of as a secondary (product listing) document. The Web page 550 may include a plurality of product listings 560. In this example, all of the product listings participate in an “upsell” program. Note that if a user entered the search query “digital camera” in Froogle, the product listings 560 might include one or more product listings that do not participate in the upsell program. Thus, given the same query—digital camera—the set of product listings in a Froogle-like Web page where the query is manually entered by a user (which may include both upsell and non-upsell product listings) may be different from the set of product listings in the Froogle-like Web page where the query is automatically entered in response to a generic ad being selected (which may include only upsell product listings). For example, upsell merchants could be ranked higher or be more prominently than non-upsell merchants for the product listings on the secondary document.

In FIG. 5, a secondary click of the last product listing is indicated. If merchants pay the ad serving entity per selection, such a click may trigger the accounting of compensation to the ad serving entity from the merchant. Note if the publisher of the Popular Photography and Imaging Website participates in an ad serving network where they are paid for ad selections, the primary click of generic ad 1 525 may trigger the accounting of compensation to the publisher from the ad serving entity. Alternatively, such compensation may be conditioned on the occurrence of a selection (or other payment condition) on the secondary (product listing) Web page 550.

Although not necessary, note that the secondary (product listing) Web page 550 may include additional ads 570 which may be selected by the user.

Scenario 3

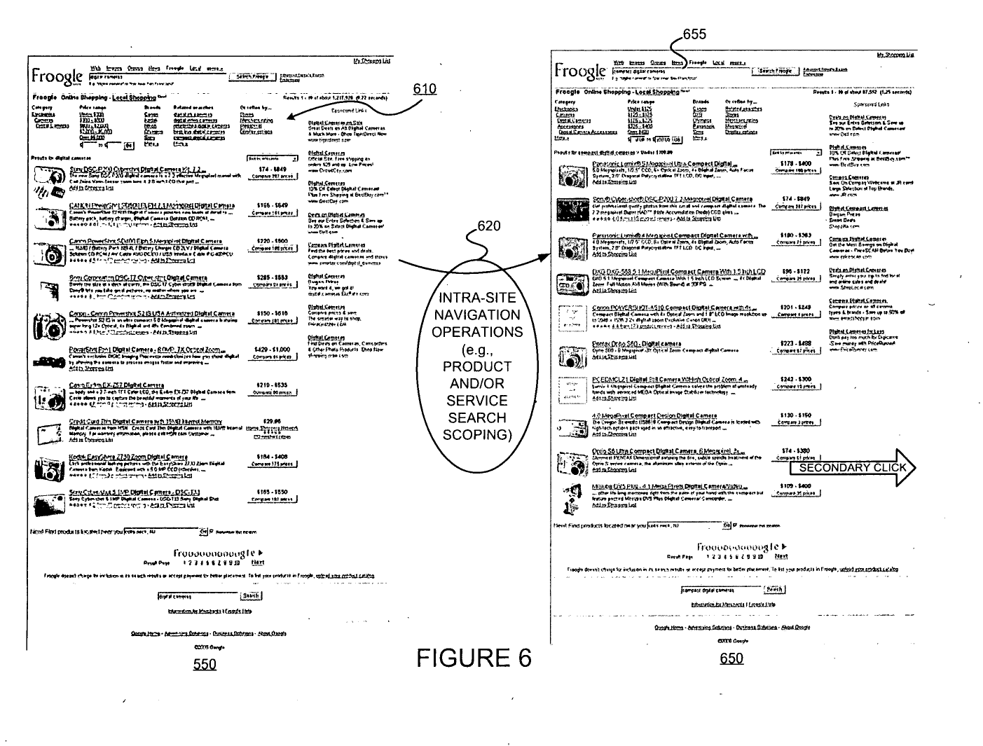

Still referring FIG. 5, note that many Froogle-like Websites allow users to scope (e.g., broaden or further narrow) the product listings. For example, referring to FIG. 6, in the Web page 550, section 610 allows the user to refine the search using a predefined price range, or specifying a price range, by indicating a brand, or by refining other product listing characteristics (e.g., merchant, megapixel, etc.), related searches, etc., as indicated by intra-site navigation operations 620. In this example, the user selected the “Related Search” of “compact digital cameras” as shown in refined product listing Web page 650. The product listings on the refined product listing Web page 650 might also be limited to those participating in an upsell program. In this case, a selection of a product listing on the product listing Web page 650 is treated the same, for purposes of compensation, as the selection of a product listing on the secondary (product listing) Web page 550. That is, a product listing selection on Web page 650 is a secondary click just like a product listing selection on Web page 550. Thus, the tertiary Web page 650 (and other Web pages generated by refining the scope of the secondary Web page 550) can be thought of as a secondary Web page.

In an alternative embodiment consistent with the present invention, the product listings on a tertiary (or later) Web page 650 might not be limited to those participating in an upsell program. In such an embodiment, selections of product listings on tertiary (or later) Web pages might not trigger compensation.

### § 4.5 CONCLUSIONS

As can be appreciated from the foregoing, unlike systems like Bizrate which likely have insufficient information to maximize arbitrage revenues, embodiments consistent with the present invention permit an ad serving entity (or generic ad server participating in an auction) to manage the arbitrage so that it is revenue-balanced. Advantageously, the ad serving entity still increases inventory because quality ads are now available for primary documents (e.g., content Web pages) that are vaguer or more general in nature. This can decrease lead costs to merchants, since they are not paying for a middleman. A corollary of maximizing the value paid for a Web page (that uses cost per click) is that user ad clicks are maximized. If introducing one generic ad performs better than, or equivalent to, more than one advertiser-managed ads, then the user experienced is improved (fewer ads on primary page) and economic value is higher. Thus, ad quality increases for the end user. Embodiments consistent with the present invention can also generate more leads for advertisers. Finally, embodiments consistent with the present invention can be used to increase exposure for merchants without requiring them to enter and actively manage all of the information typically needed for online advertising campaigns.

What is claimed is:

1. A computer-implemented method comprising:
a) accepting an ad request;
b) determining
1) at least one candidate generic ad, and
2) zero or more candidate advertiser-managed ads, relevant to the ad request;
c) determining a score for each of the at least one candidate generic ads and the zero or more candidate advertiser-managed ads;
d) determining a set including:
1) at least one of the candidate generic ads, and/or
2) at least one of the candidate advertiser-managed ads, using the scores; and
e) serving the determined set of (i) at least one of the candidate generic ads, and/or (ii) at least one of the candidate advertiser-managed ads.

2. The computer-implemented method of claim 1 wherein each of the zero or more candidate advertiser-managed ads is associated with advertiser-specified offer information, and
wherein each of the at least one candidate generic ad is associated with offer information automatically generated by an ad serving entity.

3. The computer-implemented method of claim 2 wherein each of the at least one candidate generic ads includes a link to a product listing document, and wherein the offer information automatically generated by the ad serving entity and associated with the generic ad is determined using an expected revenue per impression of the product listing document.

4. The computer-implemented method of claim 2 wherein each of the at least one candidate generic ads includes executable code initiating the generation of a product listing document, and wherein the offer information automatically generated by the ad serving entity and associated with the generic ad is determined using an expected revenue per impression of the product listing document.

5. The computer-implemented method of claim 1 wherein the determined set of (i) at least one of the candidate generic ads, and/or (ii) at least one of the candidate advertiser-managed ads is served for rendering on a primary document, and
wherein an ad serving entity compensates a publisher of the primary document for each impression of any advertiser-managed ad, but does not compensate a publisher of the primary document for each impression of any generic ad unless a subsequent condition is met.

6. The computer-implemented method of claim 5 wherein the subsequent condition is a user selection of a generic ad.

7. The computer-implemented method of claim 5 wherein the subsequent condition is both (1) a user selection of a generic ad, wherein the generic ad includes a link to a product listing document, and (2) a user selection of a product listing on the product listing document.

8. The computer-implemented method of claim 5 wherein the subsequent condition is both (1) a user selection of a generic ad, wherein the generic ad includes executable code initiating the generation of a product listing document, and (2) a user selection of a product listing on the product listing document.

9. The computer-implemented method of claim 5 wherein the subsequent condition is all of (1) a user selection of a generic ad, wherein the generic ad includes a link to a product listing document, (2) a user selection of a product listing on the product listing document, and (3) a user conversion on (A) a document linked from the selected product listing, or (B) a process initiated by the user selection of the product listing.

10. The computer-implemented method of claim 5 wherein the subsequent condition is all of (1) a user selection of a generic ad, wherein the generic ad includes executable code initiating the generation of a product listing document, (2) a user selection of a product listing on the product listing document, and (3) a user conversion on (A) a document linked from the selected product listing, or (B) a process initiated by the user selection of the product listing.

11. The computer-implemented method of claim 1 wherein the determined set of (i) at least one of the candidate generic ads, and/or (ii) at least one of the candidate advertiser-managed ads is served for rendering on a primary document, and
wherein an ad serving entity compensates a publisher of the primary document for each user selection of any advertiser-managed ad, but does not compensate a publisher of the primary document for each user selection of any generic ad unless a subsequent condition is met.

12. The computer-implemented method of claim 11 wherein each of the at least one candidate generic ads includes a link to a product listing document including a plurality of product listings from a plurality of different merchants, and
wherein the subsequent condition is met if a product listing is selected.

13. The computer-implemented method of claim 11 wherein each of the at least one candidate generic ads includes executable code initiating the generation of a product listing document including a plurality of product listings from a plurality of different merchants, and
wherein the subsequent condition is met if a product listing is selected.

14. The computer-implemented method of claim 11 wherein each of the at least one candidate generic ads includes a link to a product listing document including a plurality of product listings from a plurality of different merchants, and
wherein the subsequent condition is met if both (1) a product listing is selected, and (2) a user converts on (A) a document linked from the selected product listing, or (B) a process initiated by the user selection of the product listing.

15. The computer-implemented method of claim 11 wherein each of the at least one candidate generic ads includes executable code initiating the generation of a product listing document including a plurality of product listings from a plurality of different merchants, and
wherein the subsequent condition is met if both (1) a product listing is selected, and (2) a user conversion on (A) a document linked from the selected product listing, or (B) a process initiated by the user selection of the product listing.

16. The computer-implemented method of claim 1 wherein the determined set of (i) at least one of the candidate generic ads, and/or (ii) at least one of the candidate advertiser-managed ads is served for rendering on a primary document,
wherein an ad serving entity compensates a publisher of the primary document for each impression of any advertiser-managed ad and for each impression of any generic ad,
wherein each of the at least one candidate generic ads includes a link to a product listing document including a plurality of product listings from a plurality of different merchants, and
wherein the ad serving entity is compensated by at least one of the different merchants subject to a condition being met.

17. The computer-implemented method of claim 16 wherein the condition to be met is an impression of a product listing of the at least one of the different merchants.

18. The computer-implemented method of claim 16 wherein the condition to be met is a user selection of a product listing of the at least one of the different merchants.

19. The computer-implemented method of claim 16 wherein the condition to be met is both (1) a user selection of a product listing of the at least one of the different merchants and (2) a user conversion on (A) a document linked from the selected product listing, or (B) a process initiated by the user selection of the product listing.

20. The computer-implemented method of claim 1 wherein the determined set of (i) at least one of the candidate generic ads, and (ii) at least one of the candidate advertiser-managed ads is served for rendering on a primary document,
wherein an ad serving entity compensates a publisher of the primary document for each impression of any advertiser-managed ad and for each impression of any generic ad,
wherein each of the at least one candidate generic ads includes executable code initiating the generation of a product listing document including a plurality of product listings from a plurality of different merchants, and
wherein the ad serving entity is compensated by at least one of the different merchants subject to a condition being met.

21. The computer-implemented method of claim 20 wherein the condition to be met is an impression of a product listing of the at least one of the different merchants.

22. The computer-implemented method of claim 20 wherein the condition to be met is a user selection of a product listing of the at least one of the different merchants.

23. The computer-implemented method of claim 20 wherein the condition to be met is both (1) a user selection of a product listing of the at least one of the different merchants and (2) a user conversion on (A) a document linked from the selected product listing, or (B) a process initiated by the user selection of the product listing.

24. The computer-implemented method of claim 1 wherein the determined set of (i) at least one of the candidate generic ads, and/or (ii) at least one of the candidate advertiser-managed ads is served for rendering on a primary document,
wherein an ad serving entity compensates a publisher of the primary document for each selection of any advertiser-managed ad and for each selection of any generic ad,
wherein each of the at least one candidate generic ads includes a link to a product listing document including a plurality of product listings from a plurality of different merchants, and
wherein the ad serving entity is compensated by at least one of the different merchants subject to a condition being met.

25. The computer-implemented method of claim 24 wherein the condition to be met is an impression of a product listing of the at least one of the different merchants.

26. The computer-implemented method of claim 24 wherein the condition to be met is a user selection of a product listing of the at least one of the different merchants.

27. The computer-implemented method of claim 24 wherein the condition to be met is a user conversion on (A) a document linked from a product listing of the at least one of the different merchants, or (B) a process initiated by the user selection of the product listing.

28. The computer-implemented method of claim 1 wherein the determined set of (i) at least one of the candidate generic ads, and/or (ii) at least one of the candidate advertiser-managed ads is served for rendering on a primary document,
wherein an ad serving entity compensates a publisher of the primary document for each selection of any advertiser managed ad and for each selection of any generic ad,
wherein each of the at least one generic ad includes executable code initiating the generation of a product listing document including a plurality of product listings from a plurality of different merchants, and
wherein the ad serving entity is compensated by at least one of the different merchants subject to a condition being met.

29. The computer-implemented method of claim 28 wherein the condition to be met is an impression of a product listing of the at least one of the different merchants.

30. The computer-implemented method of claim 28 wherein the condition to be met is a user selection of a product listing of the at least one of the different merchants.

31. The computer-implemented method of claim 28 wherein the condition to be met is a user conversion on (A) a document linked from a product listing of the at least one of the different merchants, or (B) a process initiated by the user selection of the product listing.

32. A computer-implemented method comprising:
a) accepting an ad request;
b)) determining
1) at least one candidate ad from a first source, and
2) zero or more candidate ads from a second source, relevant to the ad request;
c) determining a score for each of the candidate ads from the first source and the candidate ads from the second source;
d) determining a set including:
1) at least one of the candidate ads from the first source, and/or
2) at least one of the candidate ads from the second source, using the scores; and
e) serving the determined set of (i) at least one of the candidate ads from the first source, and (ii) at least one of the candidate ads from the second source.

33. The computer-implemented method of claim 32 wherein the determined set (i) at least one of the candidate ads from the first source, and/or (ii) at least one of the candidate ads from the second source is served for rendering on a primary document,
wherein each of the at least one of the candidate ads from the first source includes a link to a product listing document,
wherein under the second compensation scheme, an ad serving entity compensates a publisher of the primary document for each impression of any ad of the second type, and
wherein under the first compensation scheme, the ad serving entity does not compensate a publisher of the primary document for each impression of any ad of the first type unless a subsequent condition is met.

34. The computer-implemented method of claim 33 wherein the subsequent condition is a user selection of the ad of the first type.

35. The computer-implemented method of claim 33 wherein the product listing document includes a plurality of product listings from a plurality of different merchants, and
wherein the subsequent condition is both (1) a user selection of the ad of the first type, and (2) a user selection of the one of the plurality of product listings.

36. The computer-implemented method of claim 33 wherein the product listing document includes a plurality of product listings from a plurality of different merchants, and
wherein the subsequent condition is all of (1) a user selection of the ad of the first type, (2) a user selection of the one of the plurality of product listings, and (3) a user conversion on (A) a document linked from the selected product listing, or (B) a process initiated by the user selection of the product listing.

37. The computer-implemented method of claim 32 wherein the determined set of (i) at least one of the candidate ads from the first source, and/or (ii) at least one of the candidate ads from the second source is served for rendering on a primary document,
wherein each of the at least one candidate ads from the first source includes executable code initiating the generation of a product listing document,
wherein under the second compensation scheme, an ad serving entity compensates a publisher of the primary document for each impression of any ad of the second type, and
wherein under the first compensation scheme, the ad serving entity does not compensate a publisher of the primary document for each impression of any ad of the first type unless a subsequent condition is met.

38. The computer-implemented method of claim 37 wherein the subsequent condition is a user selection of the ad of the first type.

39. The computer-implemented method of claim 37 wherein the product listing document includes a plurality of product listings from a plurality of different merchants, and
wherein the subsequent condition is both (1) a user selection of the ad of the first type, and (2) a user selection of the one of the plurality of product listings.

40. The computer-implemented method of claim 37 wherein the product listing document includes a plurality of product listings from a plurality of different merchants, and
wherein the subsequent condition is all of (1) a user selection of the ad of the first type, (2) a user selection of the one of the plurality of product listings, and (3) a user conversion on (A) a document linked from the selected product listing, or (B) a process initiated by the user selection of the product listing.

41. The computer-implemented method of claim 28 wherein the determined set of (i) at least one of the candidate ads from the first source, and/or (ii) at least one of the candidate ads from the second source is served for rendering on a primary document,
wherein each of at least one of the candidate ads from the first source includes a link to a product listing document including a plurality of product listings from a plurality of different merchants,
wherein an ad serving entity
compensates a publisher of the primary document for each impression of any ad of the second type, and
is compensated by an advertiser of any ad of the second type for each impression of the ad of the second type,
under the second compensations scheme, and
wherein the ad serving entity
compensates a publisher of the primary document for each impression of any ad of the first type, and
is compensated by at least one of the different merchants subject to a condition being met,
under the first compensation scheme.

42. The computer-implemented method of claim 41 wherein the condition to be met is an impression of a product listing of the at least one of the different merchants.

43. The computer-implemented method of claim 41 wherein the condition to be met is a user selection of a product listing of the at least one of the different merchants.

44. The computer-implemented method of claim 41 wherein the condition to be met is both (1) a user selection of a product listing of the at least one of the different merchants, and (2) a user conversion on (A) a document linked from the selected product listing, or (B) a process initiated by the user selection of the product listing.

45. The computer-implemented method of claim 32 wherein the determined set of (i) at least one of candidate ads from the first source, and/or (ii) at least one of the candidate ads from the second source is served for rendering on a primary document,
wherein each of the at least one of the candidate ads from the first source includes executable code initiating the generation of a product listing document including a plurality of product, listings from a plurality of different merchants,
wherein an ad serving entity
compensates a publisher of the primary document for each impression of any ad of the second type, and
is compensated by an advertiser of any ad of the second type for each impression of the ad of the second type,
under the second compensations scheme, and
wherein the ad serving entity
compensates a publisher of the primary document for each impression of any ad of the first type, and
is compensated by at least one of the different merchants subject to a condition being met,
under the first compensation scheme.

46. The computer-implemented method of claim 45 wherein the condition to be met is an impression of a product listing of the at least one of the different merchants.

47. The computer-implemented method of claim 45 wherein the condition to be met is a user selection of a product listing of the at least one of the different merchants.

48. The computer-implemented method of claim 45 wherein the condition to be met is both (1) a user selection of a product listing of the at least one of the different merchants, and (2) a user conversion on (A) a document linked from the selected product listing, or (B) a process initiated by the user selection of the product listing.

49. The computer-implemented method of claim 32 wherein the determined set of (i) at least one of the candidate ads from the first source, and/or (ii) at least one of the candidate ads from the second source is served for rendering on a primary document,
wherein each of the at least one of the candidate ads from the first source includes a link to a product listing document including a plurality of product listings from a plurality of different merchants,
wherein an ad serving entity
compensates a publisher of the primary document for each selection of any ad of the second type, and
is compensated by an advertiser of any ad of the second type for each selection of the ad of the second type,
under the second compensations scheme, and
wherein the ad serving entity
compensates a publisher of the primary document for each selection of any ad of the first type, and
is compensated by at least one of the different merchants subject to a condition being met,
under the first compensation scheme.

50. The computer-implemented method of claim 49 wherein the condition to be met is a user selection of a product listing of the at least one of the different merchants.

51. The computer-implemented method of claim 49 wherein the condition to be met is both (1) a user selection of a product listing of the at least one of the different merchants, and (2) a user conversion on (A) a document linked from the selected product listing, or (B) a process initiated by the user selection of the product listing.

52. The computer-implemented method of claim 32 wherein the determined set of (i) at least one of the candidate ads from the first source, and/or (ii) at least one of the candidate ads from the second source is served for rendering on a primary document,
wherein each of the at least one of the candidate ads from the first source includes executable code initiating the generation of a product listing document including a plurality of product listings from a plurality of different merchants,
wherein an ad serving entity
compensates a publisher of the primary document for each selection of any ad of the second type, and
is compensated by an advertiser of any ad of the second type for each selection of the ad of the second type, and
under the second compensations scheme
wherein the ad serving entity
compensates a publisher of the primary document for each selection of any ad of the first type, and
is compensated by at least one of the different merchants subject to a condition being met,
under the first compensation scheme.

53. The computer-implemented method of claim 52 wherein the condition to be met is a user selection of a product listing of the at least one of the different merchants.

54. The computer-implemented method of claim 52 wherein the condition to be met is both (1) a user selection of a product listing of the at least one of the different merchants, and (2) a user conversion on (A) a document linked from the selected product listing, or (B) a process initiated by the user selection of the product listing.

55. Apparatus comprising:
a) means for accepting an ad request;
b) means for determining
1) at least one candidate generic ad, and
2) zero or more candidate advertiser-managed ads, relevant to the ad request;
c) means for determining a score for each of the at least one candidate generic ads and the zero or more candidate advertiser-managed ads;
d) means for determining a set including:
1) at least one of the candidate generic ads, and/or
2) at least one of the candidate advertiser-managed ads, using the scores; and
e) means for serving the determined set of (i) at least one of the candidate generic ads, and/or (ii) at least one of the candidate advertiser-managed ads.

56. A computer-implemented method comprising:
a) means for accepting an ad request;
b) means for determining
1) at least one candidate ad from a first source, and
2) zero or more candidate ads from a second source, relevant to the ad request;
c) means for determining a score for each of the candidate ads from the first source and the candidate ads from the second source;
d) means for determining a set including:
1) at least one of the candidate ads from the first source, and/or
2) at least one of the candidate ads from the second source, using the scores; and
e) means for serving the determined set of (i) at least one of the candidate ads from the first source, and (ii) at least one of the candidate ads from the second source.
